(19) United States
(12) Patent Application Publication
(10) Pub. No.: US 2002/0054053 A1
(43) Pub. Date: May 9, 2002

(54) MEDICAL INFORMATION SYSTEM HAVING DESKTOP HOME KEY FEATURE

(76) Inventors: FARRUKH SALAHUDIN NAIMI, READING, MA (US); JOHN THOMAS ANDERSSON, NEWBURYPORT, MA (US)

Correspondence Address: Agilent Techologies, Inc., Legal Department, M/S 51 UPB, 5301 Stevens Creek Blvd., Santa Clara, CA, 95052, US

(21) Appl. No.: 09/239,193

(22) Filed: Jan. 28, 1999

(51) Int. Cl. G06F 13/00

(52) U.S. Cl. 345/700

(57) ABSTRACT

A computer-based medical information system includes a medical database and a user terminal having a display screen. A desktop display is generated on the display screen. The desktop display includes a desktop control panel having a home key. One or more windows containing information relating to respective application programs are generated on the desktop display in response to user inputs. The desktop display is restored to a predefined state in response to user selection of the home key. The desktop display may be restored to a predefined state by maximizing the currently-active window on the display screen and hiding all windows other than the currently-active window.

### FIELD OF THE INVENTION

This invention relates to computerized medical information systems and, more particularly, to methods and apparatus for controlling medical information systems which utilize a desktop controller for managing application programs.

### BACKGROUND OF THE INVENTION

Computerized medical information systems are widely used to monitor, control and record many aspects of patient care in hospitals. The medical information system is designed to provide patient information at the patient's bedside and at other locations in a hospital. A key element that determines the effectiveness of a medical information system is the user interface, including the presentation of information on a video display screen and the way in which the user interacts with such information.

Current information systems typically utilize a graphical user interface (GUI) for presentation of patient information. Typical displays may include a menu bar and selected patient information. A recently-developed user interface employs a clinical “desktop”. The clinical desktop implements a component architecture which allows independently-developed application programs to be integrated and gives the user a single cohesive display.

Many modem GUI based applications provide flexible controls that allow the user to alter use of available display screen space. An example is a slider bar which divides a display screen into two areas. The user may slide the slider bar to make one area bigger at the expense of the other. A common problem arises if a user moves the slider all the way to one side and one of the two areas of the display screen completely disappears. Often the way to restore the lost area is application specific and may not be apparent to the user.

Most applications allow their windows to be moved, resized or hidden, i.e., represented by an icon. This flexibility can be a problem for some users. A user may accidentally hide a window and may not know how to get it back. A user may move a window off the screen or may resize the window in a way that is no longer useable.

Often a user may perform a series of complex application specific interactions with a particular application program. In some cases, it is possible that the user may put the application in a state that is unfamiliar to the user. It is desirable to provide a simple, easy to use way for the user to recover from such confusing or unfamiliar states and to restore the display to a familiar state.

### SUMMARY OF THE INVENTION

According to a first aspect of the invention, a method is provided for controlling a computer-based medical information system which includes a medical database and a user terminal having a display screen. A desktop display is generated on the display screen. The desktop display comprises a desktop control panel having a home key. One or more windows containing information relating to respective application programs are generated on the desktop display in response to user inputs. The desktop display is restored to a predefined state in response to user selection of the home key.

The desktop display may be restored to a predefined state by identifying a currently-active window and maximizing the currently-active window on the display screen. Windows other than the currently-active window may be hidden. The currently-active window may be restored to an initial state, while retaining any information entered by the user.

Restoring the desktop display to a predefined state includes sending a home message to each of the application programs. Each application program executes a predefined home process in response to the home message. The home process may comprise restoring any window associated with the respective application program to an initial state, while retaining any information entered by the user.

According to another aspect of the invention, a medical information system is provided. The medical information system comprises a central processor, including a medical database, and at least one user terminal for entering data into the medical database. The medical information system further comprises means for generating a desktop display on the display screen, the desktop display comprising a desktop control panel having a home key, means responsive to user inputs for generating on the desktop display one or more windows containing information relating to respective application programs and means responsive to user selection of the home key for restoring the desktop display to a predefined state.

### BRIEF DESCRIPTION OF THE DRAWINGS

For a better understanding of the present invention, reference is made to the accompanying drawings, which are incorporated herein by reference and in which:

FIG. 1 is a block diagram of an example of a medical information system suitable for implementation of the present invention;

FIG. 2 is an example of a desktop display in the medical information system of FIG. 1 prior to selection of the home key;

FIG. 3 is an example of a desktop display in the medical information system of FIG. 1 after selection of the home key; and

FIG. 4 is a flowchart of an embodiment of a process that is executed in response to user selection of the home key.

### DETAILED DESCRIPTION

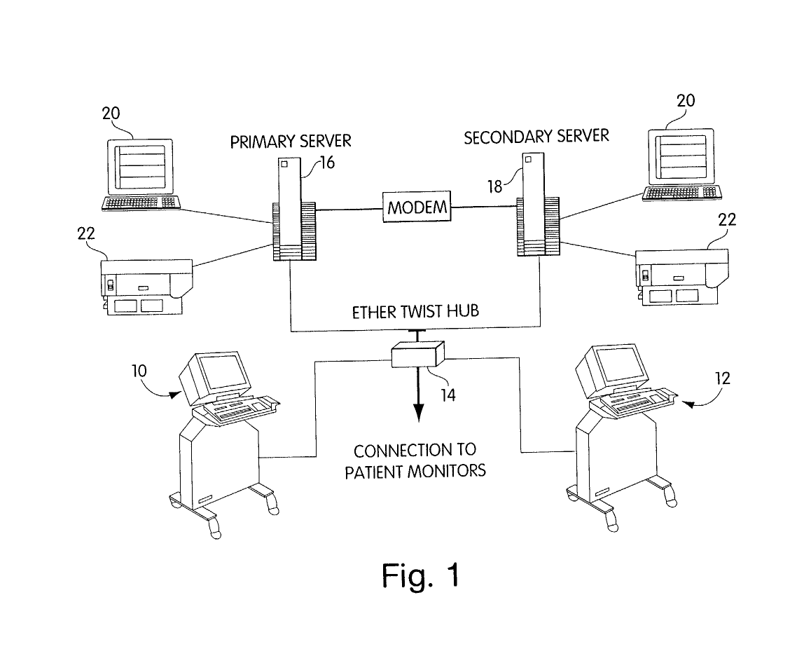

The invention is preferably practiced in a computerized medical information system, or clinical information system. The medical information system is designed to provide patient information at the patient's bedside and elsewhere in a hospital. An example of a basic medical information system is shown in FIG. 1. The system uses a client-server architecture wherein a central server supplies data and controls the flow of information to workstations (clients) located at each patient bedside. The client-server architecture eliminates the need for database storage at each workstation.

As shown in FIG. 1, workstations 10 and 12 are connected through a network hub 14 to redundant central servers 16 and 18. Each of the central servers 16 and 18 includes a central processor, memory and disk storage. The servers 16 and 18 perform centralized functions, such as database services, bedside device interface services, hospital system interface services and report services. Each central server typically includes a system manager terminal 20 and a printer 22. Workstations, only two of which are shown in FIG. 1, are typically located at patient bedsides and other locations as required throughout the hospital. Each workstation contains user interface programs and all application programs run by the workstation. The system may also be connected through hub 14 to patient monitors at selected patient bedsides. The patient monitors supply physiological information to the database. An example of a medical information system of the type shown and described is the HP CareVue 9000 system manufactured and sold by the Hewlett-Packard Company.

By way of example, workstations 10 and 12 can be HP 9000 workstations which operate with a diskless processor and include a high resolution graphic display, keyboard and trackball. The workstations typically include 16-32 megabytes of RAM. The central servers 16 and 18 can be implemented as HP 9000 processors coupled to 1.2 gigabytes of disk storage and including 24 megabytes of RAM. The system preferably uses the HP-UX operating system, a robust implementation of the AT&T Unix system V.2. The system also uses the X/Windows graphic user interface. The database is comprised of an HP-Allbase relational database and an object oriented database shell. The system database is shadowed, meaning that it is maintained on both central servers 16 and 18. Both copies of the database are updated with each transaction. Data is initially stored at the workstation and is moved to the server to be stored in the medical database.

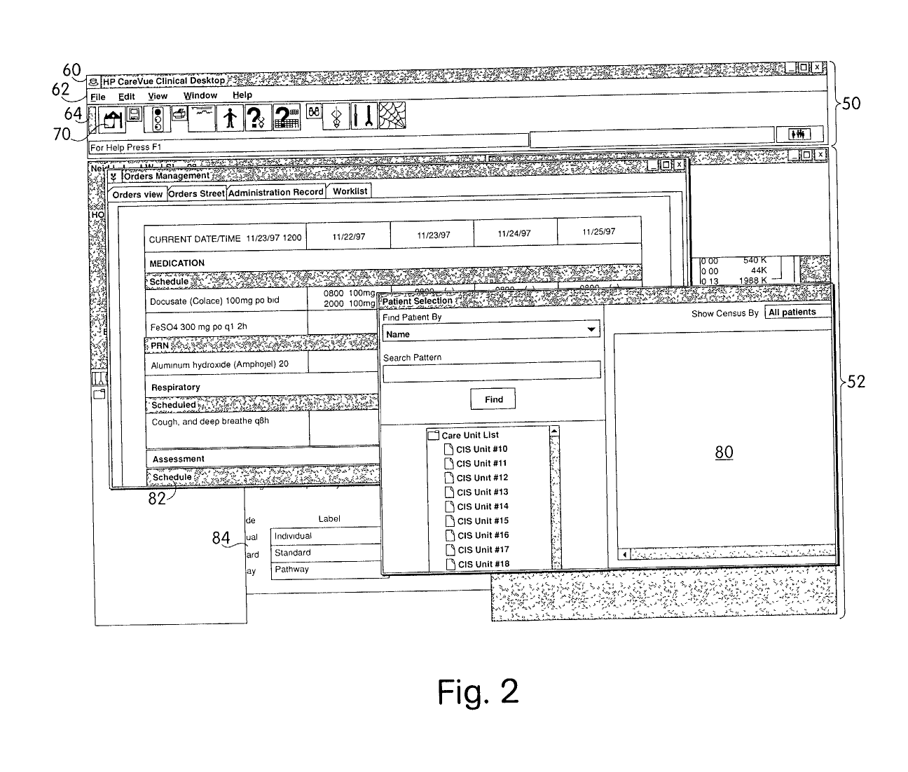

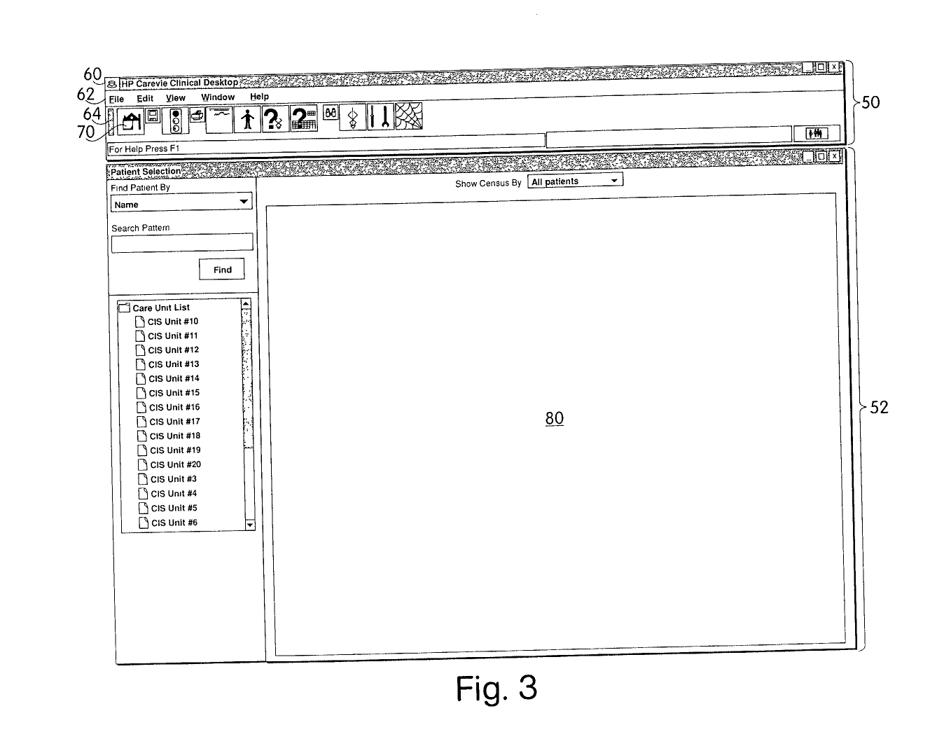

Examples of clinical desktop displays, as they may appear on the display screens of workstations 10, 12 (FIG. 1), are shown in FIGS. 2 and 3. A desktop controller manages application programs (applications) and controls the desktop display. The desktop controller allows independently-developed applications to be integrated and gives the user a single cohesive display. Components of the clinical desktop display include a desktop control panel 50 and a window area 52. Desktop control panel 50 includes functions for managing one or more application programs. Window area 52 is used for display of one or more windows containing information relating to respective applications.

Desktop control panel 50 may include a title bar 60, a menu bar 62 and a tool bar 64. The menu bar includes conventional menu bar keys such as a file key, an edit key, a view key, a window key and a help key. Selection of a key may generate a menu of functions available to the user. Tool bar 64 includes icons for selecting various functions. Examples include a save icon, a logoff icon and a print icon. In addition, tool bar 64 may include an icon for each application program that has been opened. A home key 70 permits the user to return the desktop display to a predefined state, as described in detail below.

In the example of FIG. 2, window area 52 contains a patient selection window 80, an orders management window 82 and an application configuration window 84. Each window represents an application that has been opened by the user. Various windows may be partially or entirely hidden by other windows. According to the conventional Windows environment, the currently-active window is on top (not hidden). All windows, including hidden windows, are considered to be active until they are closed.

The desktop display of FIG. 2 is shown as an example of a display which may be confusing, unfamiliar or otherwise unacceptable to the user. For example, the user may not know how to exit from this state. According to a feature of the invention, the home key 70 permits the user to return the desktop display to a predefined state. In order to initiate the home key function, the user selects home key 70 with a mouse or other pointing device. In response to selection of the home key 70, the system automatically restores the display to a predefined state. In one embodiment, the system maximizes the currently-active window on the display screen and hides all other active windows. Thus, with reference to FIG. 3, following selection of home key 70, patient selection window 80 is maximized to fill window area 52, and windows 82 and 84 are hidden. The user can then proceed with further operations. In the embodiment of FIGS. 2 and 3, the predefined state presented upon selection of the home key is the maximized, currently-active window. Each window, including the currently-active window and any hidden windows, may be restored to an initial state, such as the state when the application is opened, but information that may have been entered by the user is retained. It will be understood that different predefined states may be utilized in different applications and in different situations.

The home key feature is a useability enhancement feature. The home key 70 that appears in tool bar 64 may be implemented as an icon including the image of a house. The purpose of the home key is to return the user's desktop display and applications managed by the desktop controller to a predefined state that is familiar to the user. This feature may be valuable to novice users, who may find themselves in a state where they do not know what to do next. Selecting the home key 70 on the desktop tool bar restores the desktop to a familiar and predefined state.

Clinical applications are often quite complex. Most clinicians use several clinical applications on their desktop at the same time. This makes the situation even more complex and increases the possibility of the user becoming disoriented. No matter how disoriented or confused the user may become, the selection of the home key provides a way to restore the desktop display to a familiar and predefined state.

The home key feature relies on the component architecture of the desktop. Specifically, it relies on the fact that all applications managed by the desktop controller implement a specific interface in order to be compliant with the architecture. The interface defines a process called “home”. Each application implements the home process to restore its GUI to a predefined, application-specific and user-friendly visual and internal state. The desktop home key is configured to call the home process on each application managed by the desktop.

The architecture does not prescribe the exact response that is to be implemented by each application when the home process is called. Instead, the architecture prescribes general guidelines to the effect that each application should restore its visual and internal state to a predefined, application-specific and familiar default state.

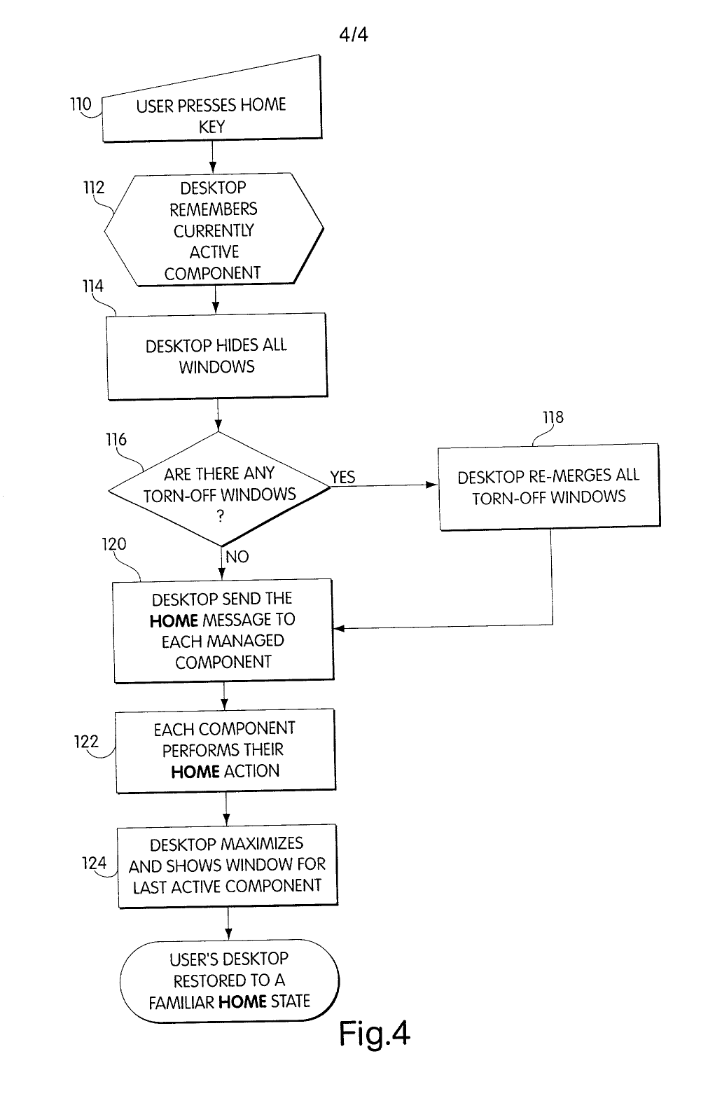

An example of the operations that may be performed in response to user selection of the home key is shown in the flow chart of FIG. 4. In step 110, the user presses the home key 70. In step 112, the desktop controller identifies and remembers the currently-active application component. In step 114, the desktop controller hides all windows.

In step 116, a determination is made as to whether there are any “torn off” windows. The desktop controller may provide the ability to tear off an application component from its parent and make it appear in a newly-created and separate window. When the user is finished with the need to view the application in a separate window, the application component can be merged back into its parent window. If there are torn off windows, the desktop controller merges all torn off windows into the respective parent windows in step 118.

Following step 116 or 120, the desktop controller sends the home message to each managed application component in step 120. In step 122, each application component performs its home process. As noted above, the home process may vary from application to application. In general, the home process restores any windows associated with the application to a predefined state that is likely to be recognized by the user. For example, the predefined state may be the initial state of the window when the application is opened, with any information entered by the user being retained. Examples of home process operations include, but are not limited to, resetting any dialog boxes that have been opened, restoring any sliding or hidden windows to their normal positions, discarding visual changes made by the user, and retaining information entered by the user.

In step 124, the desktop controller maximizes and shows the window for the currently-active component, thus restoring the user's desktop to a familiar and predefined home state.

The home key feature provides a single consistent control to enable independently-developed and third party-developed applications to be more user-friendly. The home key feature requires very little additional functionality from participating applications.

Having now described a few embodiments of the invention, it should be apparent to those skilled in the art that the foregoing is merely illustrative and not limiting, having been presented by way of example only. Numerous modifications and other embodiments are within the scope of one of ordinary skill in the art and are contemplated as falling within the scope of the invention.

What is claimed is:

1. A method for controlling a computer-based medical information system including a medical database and a user terminal having a display screen, comprising the steps of:
generating a desktop display on the display screen, said desktop display comprising a desktop control panel having a home key;
in response to user inputs, generating on said desktop display one or more windows containing information relating to respective application programs; and
in response to user selection of the home key, restoring the desktop display to a predefined state.

2. A method as defined in claim 1 wherein the step of restoring the desktop display to a predefined state comprises identifying a currently-active window and maximizing the currently-active window on the display screen.

3. A method as defined in claim 1 wherein the step of restoring the desktop display to a predefined state comprises identifying a currently-active window, maximizing the currently-active window on the display screen and hiding all windows other than the currently-active window.

4. A method as defined in claim 3 wherein the step of restoring the desktop display to a predefined state further comprises restoring the currently-active window to an initial state, while retaining any information entered by the user.

5. A method as defined in claim 1 wherein the step of restoring the desktop display to a predefined state comprises sending a home message to each of said application programs, wherein each of said application programs executes a predefined home process in response to the home message.

6. A method as defined in claim 5 wherein the step of executing a home process comprises restoring any window associated with the respective application program to an initial state, while retaining any information entered by the user.

7. A method as defined in claim 1 wherein the step of restoring the desktop display to a predefined state comprises merging windows torn off from others of said windows into respective parent windows.

8. A medical information system comprising:
a central processor, including a medical database, and at least one user terminal for entering data into said medical database, said user terminal including a display screen;
means for generating a desktop display on the display screen, said desktop display comprising a desktop control panel having a home key;
means responsive to user inputs for generating on said desktop display one or more windows containing information relating to respective application programs; and
means responsive to user selection of the home key for restoring the desktop display to a predefined state.

9. A medical information system as defined in claim 8 wherein said means for restoring the desktop display to a predefined state comprises means for identifying a currently-active window and means for maximizing the currently-active window on the display screen.

10. A medical information system as defined in claim 9 wherein said means for restoring the desktop display to a predefined state further comprises means for hiding all windows other than the currently-active window.

11. A medical information system as defined in claim 9 wherein said means for restoring the desktop display to a predefined state further comprises restoring the currently-active window to an initial state, while retaining any information entered by the user.

12. A medical information system as defined in claim 8 wherein said means for restoring the desktop display to a predefined state comprises means for sending a home message to each of said application programs, wherein each of said application programs comprises means for executing a predefined home process in response to the home message.

13. A medical information system as defined in claim 12 wherein said means for executing a predefined home process comprises means for restoring any window associated with the respective application program to an initial state, while retaining any information entered by the user.

14. A medical information system as defined in claim 8 wherein said means for restoring the desktop display to a predefined state comprises means for merging windows torn off from others of said windows into respective parent windows.
